(19) United States
(12) Patent Application Publication
(10) Pub. No.: US 2015/0149292 A1
(43) Pub. Date: May 28, 2015

(54) LEVERAGING SENSORS ON SMART MOBILE PHONES AND TABLETS TO CREATE ADVERTISEMENTS TO REPLICATE A REAL WORLD EXPERIENCE

(71) Applicant: John C. FEGHALI, Pittsburgh, PA (US)

(72) Inventor: John C. FEGHALI, Pittsburgh, PA (US)

(21) Appl. No.: 14/553,318

(22) Filed: Nov. 25, 2014

Related U.S. Application Data
(60) Provisional application No. 61/908,661, filed on Nov. 25, 2013.

(51) Int. Cl. G06Q 30/02; H04W 4/04

(52) U.S. Cl. CPC G06Q 30/0267; H04W 4/04
USPC 705/14.64

(57) ABSTRACT

Systems, methods, and apparatus are described herein for replicating a real world experience consuming a product or service to advertise products or services. Data from sensors on mobile devices, tablets, computers, etc. may be read and translated into data corresponding to an action. A user of the computing device (e.g., mobile phone, tablet, computer, etc.) performs a required action by activating the appropriate sensors, which may provide the user with a benefit, reward, or incentive. The action taken by the user represents a real world activity that a user would normally perform when consuming a product or service. Advertisers are charged once the actions associated with consuming the product or service have been performed.

### CROSS REFERENCE TO PRIOR APPLICATIONS

This application claims priority under 35 U.S.C. §119(e) to U.S. Provisional Patent Application No. 61/908,661, filed Nov. 25, 2013, titled “Leveraging Sensors on Smart Mobile Phones and Tablets to Create a Method to Replicate a Real World Experience Consuming a Product or Service for Advertising Purposes,” the disclosure of which is hereby expressly incorporated herein by reference in its entirety.

### BACKGROUND

The present disclosure relates generally to mobile advertising, and more particularly to using sensor data in mobile advertising.

Online advertising is commonly used in the advertising industry to promote products and services. These ads are typically found in websites, social media programs, etc. Today, many users use mobile electronic devices, and in particular, smartphones and tablets, as their main source for viewing online content. These devices often include a plurality of sensors that can be used to collect data. It would be desirable to implement these sensors to leverage advertisements.

### SUMMARY OF THE DISCLOSURE

According to one aspect of the disclosure, a method for providing a sensor-based message is described herein. The method may include receiving a message defining parameter for the sensor-based message, the message defining parameter including a messaging item identification, a description of a real world action to be simulated, and an output to be displayed when the real world action is simulated; identifying a sensor to collect sensor data corresponding to the real world action to be simulated; storing the sensor-based message, the message defining parameter and the identified sensor; and generating a billing event for the sensor-based message each time the real world action is sensed.

According to one aspect of the disclosure, a method for sending a message during a text messaging session is described herein. The method may include selecting, at a first computing device, a messaging item to include in a text messaging communication, the messaging item being associated with a real world activity to be simulated and an output to be displayed upon sensing a message trigger on the first computing device; determining the message trigger required to transmit the messaging item; collecting sensor data from a sensor in the first computing device; comparing the collected sensor data to the determined message trigger to determine whether the real world activity is simulated; and transmitting the text messaging communication to a second computing device. The message may be displayed at the first computing device and the second computing device.

According to one aspect of the disclosure, a method for providing a message to a mobile computing device is described herein. The method may include selecting a messaging item to associate with a message output, the message output being triggered by an action sensed using a sensor on the mobile computing device; transmitting, to a server computing device, a description of an output to be displayed based on the action sensed; and receiving a bill for the messaging item each time the action is sensed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced.

FIG. 1 is a block diagram illustrating one aspect of a system for providing messages based on sensors.

FIG. 2 is a block diagram illustrating an example of a computing device, according to aspects of the disclosure.

FIG. 3 is a block diagram illustrating an example of a server computing device, according to aspects of the disclosure.

FIG. 4 illustrates a layered architecture of a messaging system, according to aspects of the disclosure.

FIG. 5 is a flowchart depicting a method for managing a messaging campaign, according to aspects of the disclosure.

FIG. 6 is a flowchart depicting a method for consuming messages, according to according to aspects of the disclosure.

FIGS. 7-9 illustrate examples of sensor based advertisements, according to some aspects of the disclosure.

### DETAILED DESCRIPTION

The embodiments of the disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure, which is defined solely by the appended claims and applicable law. Moreover, it is noted that like reference numerals represent similar parts throughout the several views of the drawings.

Systems, methods, and apparatus are described herein for replicating a real world experience consuming a product or service to advertise products or services. Data from sensors on mobile devices, tablets, computers, etc. may be read and translated into data corresponding to an action. A user of the computing device (e.g., mobile phone, tablet, computer, etc.) performs a required action by activating the appropriate sensors, which may provide the user with a benefit, reward, or incentive. The action taken by the user represents a real world activity that a user would normally perform when consuming a product or service. Messengers (e.g., advertisers) are charged once the actions associated with consuming the product or service have been performed.

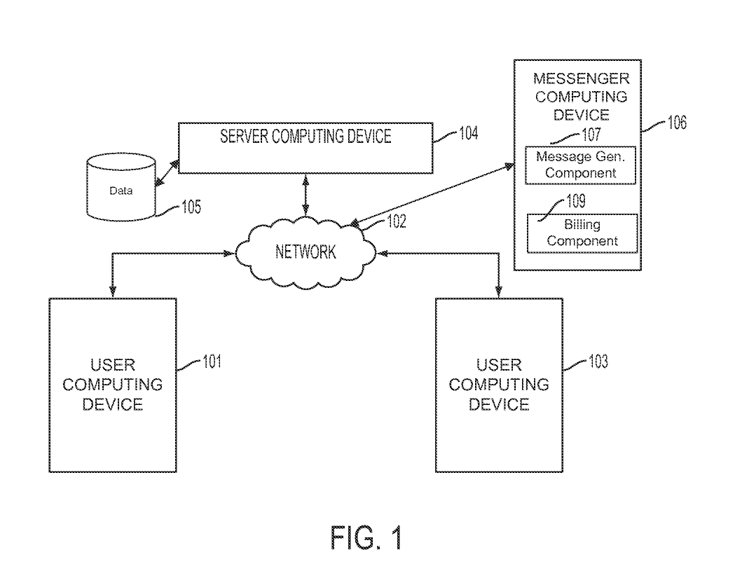

FIG. 1 illustrates an example of aspects of a system for providing messages based on the use of sensors on a smart computing device, such as a mobile phone, tablet, etc. The messages may include, e.g., advertisements. A server computing device 104 (e.g., a server) may communicate with a messenger computing device 106 and one or more user computing devices, such as devices 101 and 103, over a network 102. Computing device 101 and computing device 103 may communicate via one or more communication protocols such as, for example, text, instant messaging, email, Internet, etc. While two computing devices are illustrated in FIG. 1, this is merely illustrative. A single computing device or more than two computing devices may implement the systems and methods described herein. The server computing device 104 may provide one or more applications that enable the messenger computing device 106 to provide messages, such as advertisements for products or services to user computing devices 101, 103. The messages may be associated with movements, sounds, or other actions that a user may follow to view the message. When the user performs the required action, the user may unlock access to a service associated with the application, which will be paid for by the messenger, or may receive a discount or other incentive or reward related to a product or service advertised by the messenger.

According to some aspects of the disclosure, the one or more applications provided by the server computing device 104 may include a text messaging application, enabling, for example, user computing devices 101 and 103 to communicate during a text messaging communication session (e.g., instant message, online chat, SMS, MMS, etc.). Each user computing device may store a local copy of the application(s), which may be periodically updated. The text message application may include a plurality of messaging items, including emoji, emoticons, avatars, and the like, and may include an option to purchase additional messaging items from an application store associated with server computing device 104. According to some aspects of the disclosure, the application store may include one or more messaging items that have been sponsored by a messenger (e.g., advertiser) such that when selected, and when any associated actions are performed, a message may be shown on the sending and/or receiving computing devices. Thus, as a result of one user performing the associated actions, a message (e.g., advertisement) may be viewed by at least two parties. According to some aspects of the disclosure, actions associated with a messaging item may be performed by a sender of a message, a receiver of a message, or both the sender and receiver of the message.

According to some aspects of the disclosure, the one or more applications provided by the server computing device 104 may be in the form of an application programming interface (API) that provides a service for other software applications. For example, APIs may be provided that can be embedded in websites, online games, social media programs, etc. Similar to the text message program, the APIs may provide messages that are associated with actions to be performed using sensors on a user computing device. Performing the associated action may reward the user with one or more incentives, such as product discounts or the like. According to some aspects of the disclosure, the message provided by the API may be sponsored by the service or software application presenting the message. For example, a coffee house may embed an API on its website to promote a new product. In accordance with other aspects of the disclosure, a message displayed on one site may be sponsored by a third party. For example, a retailer may sponsor a birthday cake messaging item that a user can include on the user's social media profile page. When the user's friends view the profile and perform the action associated with the birthday cake message (e.g., blowing out the candles on the cake), a message from the sponsor may be shown, and the user may receive an incentive, such as a product discount, gift card, or the like. The sponsor of the messaging item may be billed a negotiated per action fee each time the actions are performed.

Server computing device 104 may be communicatively coupled to a message database 105. Alternatively (or additionally), the message database 105 may be located in the server computer device 104.

The message database 105 may include a plurality of messenger storage areas, each of which may be dedicated to a particular messenger. Each messenger storage area may include a plurality of records that are configured to receive and store message defining parameters. Each messenger record includes at least one field. A messenger record may include, e.g., the following record fields: (1) a message field that is configured to receive and hold the message (e.g., an advertisement for a softdrink) that is to be produced on a user device (e.g., a smartphone); (2) a message trigger field that is configured to receive and hold message action triggers (e.g., a first trigger (i) may include determining when an icon in the message is selected by the user, a second trigger (ii) may include determining when the smartphone is moved and tilted, and a third trigger (iii) may include determining when the smartphone microphone and processors sense and determine a drinking sound made by the user); and (3) a trigger sensor field that is configured to receive and hold trigger sensor information (e.g., identifying and activating sensors on the smartphone to (i) sense when the user selects the icon in the message on the smartphone, (ii) sense when the phone is moved and tilted using, e.g., the device gyroscope or GPS receiver, and (iii) sense the drinking sound using, e.g., the device microphone). Each message field may be associated with one or more message trigger fields, and vice versa. Each message trigger field may be associated with one or more trigger sensor fields, and vice versa. The trigger sensor information in the trigger sensor field may include device sensor identification information and control instructions to instruct the user device to activate the identified sensors on the user device for the associated trigger, so as to determine when a particular message trigger has been executed. The messenger records may include additional fields. For instance, the messenger records may include a device operating system identification field (e.g., Android, IOS, Microsoft, etc.), which may be associated.

The records in the message database may be populated by the messenger computing device 106. Alternatively (or additionally), portions of the records may be generated and populated by the server computing device 104.

The message database may be configured to store the message defining parameters (e.g., a message to be produced on a device, a message trigger that causes the message to be produced on the device, a trigger sensor that activates one or more sensors to detect when a message trigger occurs to produce the message on the device) that may be received from messenger computing device 106. The message database 105 may include a lookup table (LUT) that correlates the plurality of record fields for each message that may be produced on the user computing device.

Messenger computing device 106 may include a message generating component 107 and a billing component 109. Message generating component 107 may provide access to server computing device 104, via network 102, to define one or more messages that may be provided to a user computing device. For example, the message generating component may include a user interface through which a messaging administrator or other user can define message parameters. The message parameters may include, for example, a selection of a messaging item, a description of a real world action to be simulated by a user (e.g., a message trigger), an output to be displayed upon simulating real world action, and a user reward or incentive. For example, where the message comprises an advertisement for a product or service, the message defining parameters may include a description of the product/service to be advertised, an identification of a messaging item (e.g., an avatar, emoji, emoticon or the like) to be associated with the product/service to be advertised, a real world action (e.g., message trigger(s)) that a user would take with respect to the product/service, and an output to be displayed when the user simulates the real world action using sensors on the user computing device. Billing component 109 may be configured to facilitate receiving and paying bills when actions associated with a message have been performed. Bills may be generated on a cost per action basis. That is, a messenger may be billed a negotiated rate each time a user performs actions associated with a messaging item.

One of skill in the art will recognize that computing device 101 and computing device 103 can be identical devices or different types of devices. Computing device 101 and computing device 103 may be smartphones, such as an iPhone from Apple, Inc., a BlackBerry, from Research in Motion Limited, a phone running the Android OS from Google, Inc. of Mountain View, Calif., or the like. However, each computing device may be a home personal computer (PC), a corporate PC, a laptop, a netbook, or any network-enabled computing device. Examples of network-enabled computing devices include a cellular phone, personal digital assistant (PDA), media device (such as an iPod from Apple, Inc.), an electronic tablet (such as an iPad from Apple, Inc.), or an electronic reader device (such as the Kindle from Amazon.com, Inc. of Seattle, Wash.).

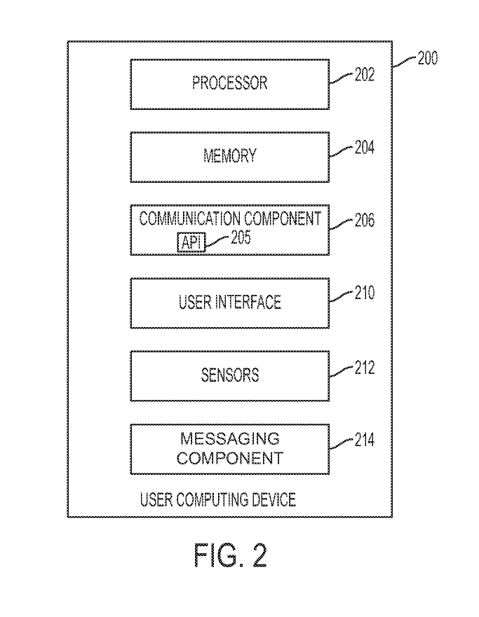

FIG. 2 shows an example of a user computing device 200 that may be used to implement aspects of the disclosure. For example, user computing device 101 and/or computing device 103, shown in FIG. 1, may include user computing device 200. User computing device 200 may include a processor 202 for carrying out processing functions associated with one or more of components and functions described herein. Processor 202 can include a single or multiple sets of processors or multi-core processors. Moreover, processor 202 can be implemented as an integrated processing system and/or a distributed processing system.

User computing device 200 further includes a memory 204, such as for storing data and/or local versions of applications being executed by processor 202. Memory 204 may include a storage area (e.g., cache memory) for storing message defining parameters for a given message. Memory 204 can include any type of memory usable by a computer, such as a computer-readable medium, a random access memory (RAM), a read only memory (ROM), tapes, magnetic discs, optical discs, volatile memory, non-volatile memory, databases, and any combination thereof.

Further, user computing device 200 may include a communications component 206 that provides a means for establishing and maintaining communications over one or more communication links with one or more parties utilizing hardware, software, and services as described herein. Communications component 206 may carry communications between components on user computing device 200, as well as between the user computing device 200 and external devices, such as devices located across a network and/or devices serially or locally connected to user computing device 200. For example, communications component 206 may include one or more buses, and may further include transmit chain components and receive chain components associated with a transmitter and receiver, respectively, operable for interfacing with external devices. In accordance with some aspects of the disclosure, communications component 206 may include one or more application programming interfaces (APIs) 205 for accessing processor 202 and/or the data from one or more sensors 212.

User computing device 200 may additionally include a user interface component 210 operable to receive inputs from a user of user computing device 200, which may be further operable to generate outputs for presentation to the user. User interface component 210 may include one or more input devices, including but not limited to a keyboard, a number pad, a mouse, a touch-sensitive display, a navigation key, a function key, a microphone, a voice recognition component, a still camera, a video camera, an audio recorder, and/or any other mechanism capable of receiving an input, or any combination thereof. Further, user interface component 210 may include one or more output devices, including but not limited to a display, a speaker, a haptic feedback mechanism, a video projector, a printer, any other mechanism capable of presenting an output, or any combination thereof.

User computing device 200 may include a plurality of sensors 212. For example, sensors 212 may include a touch screen, a microphone, a camera, an accelerometer, a light sensor, a proximity sensor, a gyroscope, a biometric reader, a temperature sensor, a compass, a global positioning satellite (GPS) sensor, and/or other sensors. The sensors 212 may be configured to collect data based on message defining parameters to determine when an action is performed by a user of the computing device. According to aspects of the disclosure, the data may be used to determine whether an action required to experience an advertisement has been performed. User computing device 200 may also include messaging component 214 configured to allow a user to send and receive messages via a text messaging application provided by server computing device 104.

According to some aspects of the disclosure, messaging component 214 may be configured to activate device sensors (e.g., a microphone) and collect sensor data to determine whether an action (e.g., a drinking sound) required to experience an output associated with a messaging item has been performed. For example, the messaging component may receive instructions that identify one or more sensors to be activated on the device and associated sensor output threshold data that may be determinative of when a user has satisfied a user action required to experience a message output. During operation, the collected sensor data (e.g., sound picked up by the device) received from the activated sensors (e.g., the device microphone) may be processed and compared to the associated sensor output thresholds (e.g., a particular sound pattern) to determine whether a user action has been carried out. When the sensed data is determined to satisfy the associated sensor output thresholds, the computing device may send the message (e.g., an image of a particular softdrink) and produce an output associated with the message (e.g., an image of the particular softdrink). In other aspects of the disclosure, messaging component 214 may be configured to transmit the sensor data to server computing device 104 for evaluation.

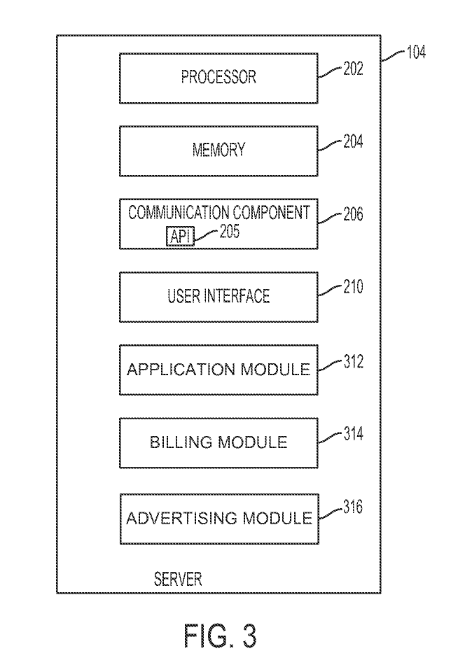

FIG. 3 illustrates an example of server computing device 104. Similar to user computing device 200, server computing device 104 may include a processor 202, memory 204, communication component 206, API 205, and user interface 210. The server computing device 104 may further include an application module 312, a billing module 314, and an advertising module 316. Application module 312 may be configured to provide one or more applications that may be used by other devices, such as computing devices 101, 103 or messenger computing device 106. For example, application module 312 may provide a text messaging application that may be downloaded and used by computing devices 101, 103 to exchange text messages, including messages having advertisements. The text message application may include a plurality of emoticons, emoji, avatars, etc. According to some aspects of the disclosure, the emoticons, emoji, avatars, etc., may be sponsored by a messenger, such as messenger computing device 106, and a user selecting a sponsored item may perform one or more actions to experience the advertisement when sending the sponsored item to a recipient. As such, both the sender and receiver may view the advertisement.

Application module 312 may also provide APIs, such as APIs 205, that may be embedded into websites, social media programs, and/or other applications, enabling sensor-based messages to be consumed via various media. Server 104 may further comprise a billing module 314.

According to aspects of the disclosure, a billing event may be created when an action associated with a message from messenger 106 has been performed. Billing module 314 may be configured to receive notifications from a user computing device when an action has been performed. The notification may include sensor data collected by the user computing device, which the billing module 314 may evaluate to determine that the correct actions. The billing module 314 may be configured to receive notifications when actions associated with a message have been performed, and to generate a bill on a cost per action basis to the messenger once such actions have been performed. Thus, according to some aspects of the disclosure, a bill may be generated, not when a user selects a messaging item, but when any actions associated with the messaging item have been performed. Advertising module 316 may be configured to facilitate access to advertising campaigns by one or more advertisers.

As described herein, messengers may setup a real world activity that they would like to replicate on a user computing device, as well as an output to be presented when the action is taken by a user. For example, a messenger can set up different movements, sounds, or actions that a user must follow to receive an incentive. Performing the action causes the output to be presented, which may include, e.g., direct advertisement of the messenger's product or service. Thus, the user is rewarded with an incentive, and the advertiser is only billed when the user performs the replicated real world action. For example, the advertiser may be an energy drink company that wants to advertise a new energy drink product. In setting up an advertising campaign, the advertiser may sponsor an energy drink graphic (emoji, emoticon, etc.). In the case or a text message application, a user may select the energy drink graphic to include in a text message to a friend. When selecting the energy drink graphic, the user may be instructed to perform an action prior to sending the graphic in order to receive a discount on the energy drink. For example, the user may be instructed to simulate drinking the energy drink by lifting the user's computing device towards the user's mouth. Data associated with this action is collected to indicate that the action has been performed. According to some aspects of the disclosure, after performing the action, a different output may appear on the user's computing device. This output may include a tag line associated with the product or any other advertising materials/graphics. The output may also be shown to the recipient of the message.

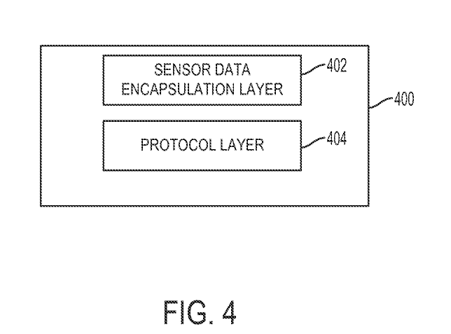

FIG. 4 shows an example of a messaging system 400, which may include multiple layers (e.g., two layers). The messaging system 400 may include a sensor data encapsulation layer 402 and a protocol layer 404. The sensor data encapsulation layer 402 may be provided for collecting and transmitting sensor data representing user actions sensed by one or more sensors on a user computing device when the user performs such actions to experience an advertisement. The sensor data may be sent to the server computing device 104 (shown in FIG. 1), where it may be associated with and referenced to a particular message in a message record, thereby making the message available for download to the user device having the messaging system 400 (e.g., 101 in FIG. 1) and/or transmission to another user device (e.g., 103 in FIG. 1). The sensor encapsulation data may be layered on top of the protocol layer 404, which may be used to transmit and/or display the message. For example, the protocol layer 404 may be a messaging protocol, a gaming protocol, a web service protocol, an Internet protocol, and/or other communication protocols.

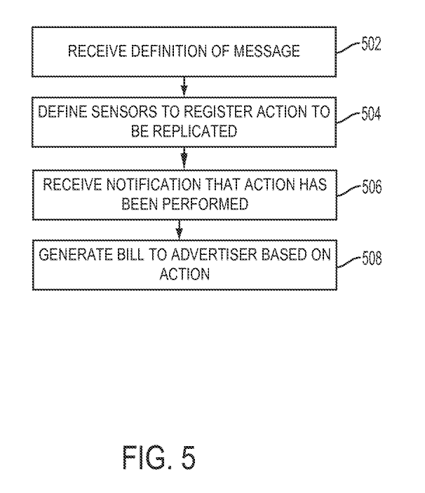

FIG. 5 is a flowchart illustrating an example of a method for managing a messaging campaign requiring a user to simulate a real word action to “consume” a product or service associated with the messenger, in accordance with aspects of the disclosure. The method 500 may be implemented, for example, by a server such as server 104 shown in FIG. 1. As shown at 502, the server may receive a message, the message including a plurality of message defining parameters. The message defining parameters may include, for example, a description of a product or service to be advertised, an identification of a messaging item (e.g., an avatar, emoji, emoticon or the like) to be associated with the product/service to be advertised, a real world action (e.g., message trigger(s) that a user would take with respect to the product/service, and an output to be displayed when the user simulates the real world action using sensors on the user computing device. In accordance with some aspects of the disclosure, the messaging item may be selected from an application store associated with the server. In other aspects, the messenger or another third party may design and/or provide the messaging item.

The real world action may be an action that a user in the real world would perform relative to the product or service. For example, if the product advertised is an energy drink, the real world action to be replicated may be “drinking” the energy drink. In addition to defining an action to be replicated, an advertiser may also associate a reward with the advertisement. Thus, a user who experiences an advertisement may be rewarded with incentives such as, for example, product discounts, free use of special features of the application program, and/or other incentives.

As shown at 504, the server may define (or identify) sensor actions to register the action being replicated. Performing the actions via the sensors may cause the message output to be displayed. In the energy drink example, a GPS, an accelerometer, a gyroscope, or the like, on the user's device may sense the position and trajectory of movement of the device as it moves towards the user's mouth, simulating the user “drinking” the energy drink.

Once the sensed actions have been defined, identified, and/or correlated with an action trigger(s), a user can select the messaging item identified in the message defining parameters. For example, where the user is a text messaging application user, the user may select a messaging item associated with a message for sending to a friend. The user may be required to perform the real world simulated action identified in the message defining parameters. Once the appropriate sensors have been activated and real world simulated action detected and determined, the receiver (friend) of the message can view the output defined in the message defining parameters. Additionally (or alternatively) the sender (user) of the message can view the output identified in the message defining parameters. As described above, the application may be an API embedded in a third party application, such as a website. Thus, the user may view and experience the message when visiting the website. As shown at 506, the server may receive notification that the action has been performed. This may trigger the server to generate a bill to the advertiser, as shown at 508. In accordance with aspects of the disclosure, the advertiser is billed only when the action associated with the advertisement has been performed.

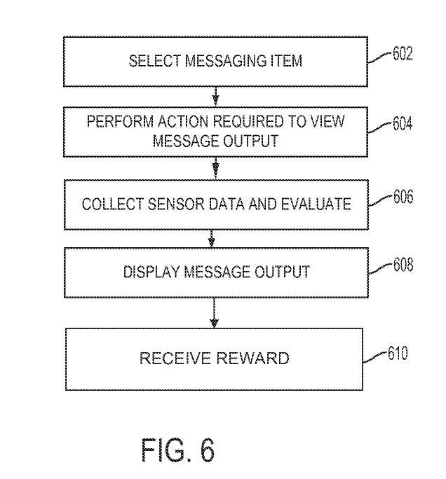

FIG. 6 is a flowchart illustrating an example of a method for consuming messages, according to some aspects of the disclosure. As shown at 602, a user may select a messaging item associated with an advertisement sponsored by a messenger. For example, the user may select a messaging item (emoji, emoticon, avatar, etc.) from a messaging application or select a link on a website. As shown at 604, the user may perform an action required to view a message output, for example, an advertisement. The action may mimic a real-word activity (e.g., drinking a soft drink, giving a hug, etc.). As shown at 606, the user device may collect sensor data and compare the sensor data to sensor data requirements. Alternatively, the user device may be configured to transmit the sensor data to a server computing device to determine whether the correct sensor data has been collected.

As shown at 608, upon determining that the correct sensor data has been collected, a message output may be displayed. In the case of a text messaging application, the message output may also be displayed on a receiving user device once the message has been sent. As shown at 610, the user may receive a reward for experiencing the advertisement.

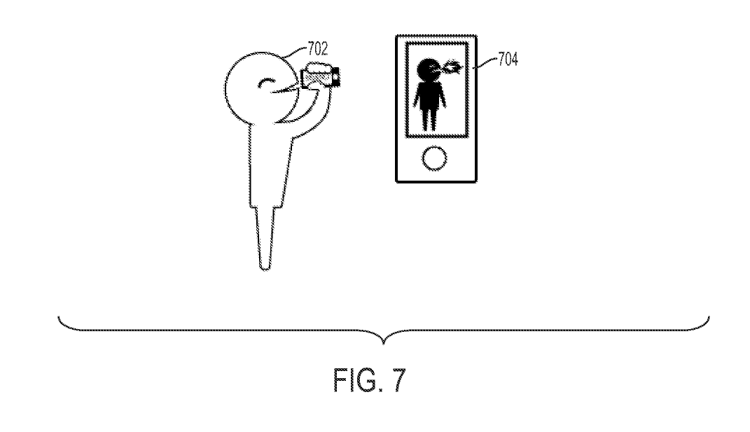

Turning now to FIG. 7, an example of a user performing actions associated with an advertisement is shown. According to this example, an advertiser may launch a new energy drink and want to advertise the drink on smart devices by asking users to pretend to drink the real drink. As shown at 702, a user is holding a phone up to her/his mouth, simulating drinking a soft drink. In response to this action, the user's device shows an avatar blowing fire or running fast, indicating increased energy, as shown at 704. The advertiser may be charged a fee each time a user drinks the digital drink in the application service, and the user may receive a reward or incentive for performing the action. While not shown in FIG. 7, in a messaging application, the messaging output may be shown to the sender (who performs the action) and/or a receiver of the message.

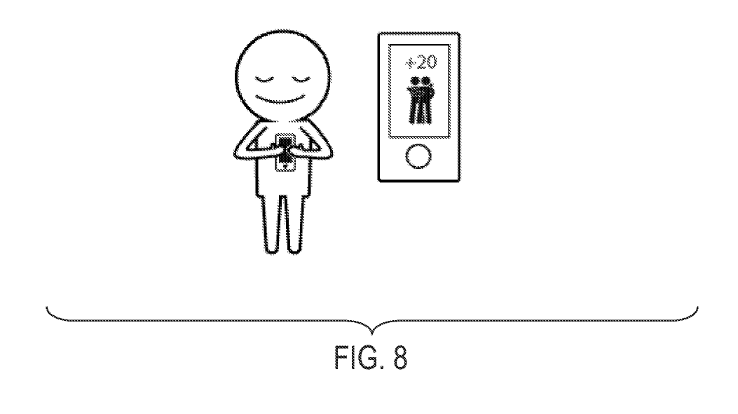

FIG. 8 illustrates another example of a sensor-based advertisement associated with a simulated real world activity. In this example, an advertiser may request a user to hug the user's phone to get extra points in a game. Each time the phone is hugged, the advertiser is charged a fee. In this regard, the camera or photo-diode sensor may be activated to detect when the device is placed, e.g., against the user's chest, thereby confirming a hug.

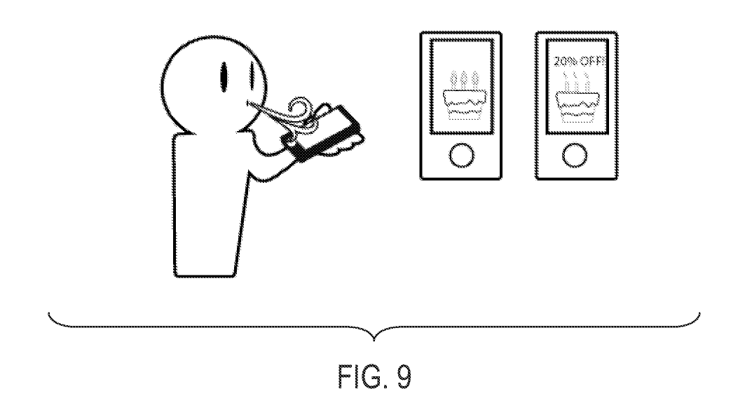

FIG. 9 illustrates yet another example of a sensor-based advertisement associated with a simulated real world activity. In this example, a user may blow off digital candles on a birthday cake to get a discount or free product from the advertiser. In this regard, the microphone may be activated to detect when the user blows on the device. Again, the advertiser is charged each time a user blows the candles. According to some aspects of the disclosure, the advertiser may limit the amount of time a single user device can receive a discount.

While various examples have been described herein, it is to be understood that such examples are given for illustrative purposes only and can be extended to other implementations and embodiments with different sets of sensors, defined types of motions, conventions, and techniques. While a number of embodiments are described herein, there is no intent to limit the disclosure to the embodiments disclosed herein. In the contrary, the intent is to cover all alternatives, modification, and equivalents apparent to those familiar with the art. For example, while advertisements are described herein that are sponsored and paid for on a cost per action basis, the disclosure is not so limited. According to some aspects of the disclosure, the messenger may be a charitable organization or the like wishing to draw attention to its cause.

Further, while a number of examples are described as an application running on a computing device, it is to be understood that the application itself, along with the ancillary functions such as sensor operation, device communications, user input, and device display generation, etc., can all be implemented in software stored in a computer readable storage medium for access as needed to run such software on the appropriate processing hardware of the computing device.

A “computer,” as used in this disclosure, means any machine, device, circuit, component, or module, or any system of machines, devices, circuits, components, modules, or the like, which are capable of manipulating data according to one or more instructions, such as, for example, without limitation, a processor, a microprocessor, a central processing unit, a general purpose computer, a super computer, a personal computer, a laptop computer, a palmtop computer, a smart phone, a cellular telephone, a tablet, a web-book, a notebook computer, a desktop computer, a workstation computer, a server, a cloud, or the like, or an array of processors, microprocessors, central processing units, general purpose computers, super computers, personal computers, laptop computers, palmtop computers, notebook computers, desktop computers, workstation computers, servers, or the like.

A “database,” as used in this disclosure, means any combination of software and/or hardware, including at least one application and/or at least one computer. The database may include a structured collection of records or data organized according to a database model, such as, for example, but not limited to at least one of a relational model, a hierarchical model, a network model or the like. The database may include a database management system application (DBMS) as is known in the art. The at least one application may include, but is not limited to, for example, an application program that can accept connections to service requests from clients by sending back responses to the clients. The database may be configured to run the at least one application, often under heavy workloads, unattended, for extended periods of time with minimal human direction.

A “network,” as used in this disclosure, means any combination of software and/or hardware, including any machine, device, circuit, component, or module, or any system of machines, devices, circuits, components, modules, or the like, which are capable of transporting signals from one location to another location, where the signals may comprise information, instructions, data, and the like. A network may include, but is not limited to, for example, at least one of a local area network (LAN), a wide area network (WAN), a metropolitan area network (MAN), a personal area network (PAN), a campus area network, a corporate area network, a global area network (GAN), a broadband area network (BAN), or the like, any of which may be configured to communicate data via a wireless and/or a wired communication medium.

A “server,” as used in this disclosure, means any combination of software and/or hardware, including at least one application and/or at least one computer to perform services for connected clients as part of a client-server architecture. The at least one server application may include, but is not limited to, for example, an application program that can accept connections to service requests from clients by sending back responses to the clients. The server may be configured to run the at least one application, often under heavy workloads, unattended, for extended periods of time with minimal human direction. The server may include a plurality of computers configured, with the at least one application being divided among the computers depending upon the workload. For example, under light loading, the at least one application can run on a single computer. However, under heavy loading, multiple computers may be required to run the at least one application. The server, or any of its computers, may also be used as a workstation.

A “communication link,” as used in this disclosure, means a wired and/or wireless medium that conveys data or information between at least two points. The wired or wireless medium may include, for example, a metallic conductor link, a radio frequency (RF) communication link, an Infrared (IR) communication link, an optical communication link, or the like, without limitation. The RF communication link may include, for example, WiFi, WiMAX, IEEE 802.11, DECT, 0G, 1G, 2G, 3G or 4G cellular standards, Bluetooth, and the like. One or more communication links may be used in an environment 100 (shown in FIG. 1) to allow sufficient data throughput and interaction between end-users (such as, e.g., agents, consumers, insurance carriers, estate planners, financial providers, web host providers, and the like). Techniques for implementing such communications links are known to those of ordinary skilled in the art.

The terms “including,” “comprising,” “having,” and variations thereof, as used in this disclosure, mean “including, but not limited to,” unless expressly specified otherwise.

The terms “a,” “an,” and “the,” as used in this disclosure, means “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

A “computer-readable medium,” as used in this disclosure, means any medium that participates in providing data (for example, instructions) which may be read by a computer. Such a medium may take many forms, including non-volatile media, volatile media, and transmission media. Non-volatile media may include, for example, optical or magnetic disks and other persistent memory. Volatile media may include dynamic random access memory (DRAM). Transmission media may include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer-readable media may be involved in carrying sequences of instructions to a computer. For example, sequences of instruction (i) may be delivered from a RAM to a processor, (ii) may be carried over a wireless transmission medium, and/or (iii) may be formatted according to numerous formats, standards or protocols, including, for example, WiFi, WiMAX, IEEE 802.11, DECT, 0G, 1G, 2G, 3G or 4G cellular standards, Bluetooth, or the like.

While the disclosure has been described in terms of exemplary embodiments, those skilled in the art will recognize that the disclosure can be practiced with modifications in the spirit and scope of the appended claims. These examples given above are merely illustrative and are not meant to be an exhaustive list of all possible designs, embodiments, applications or modifications of the disclosure.

What is claimed:

1. A method for providing a sensor-based message, the method comprising:
receiving a message defining parameter for the sensor-based message, the message defining parameter including a messaging item identification, a description of a real world action to be simulated, and an output to be displayed when the real world action is simulated;
identifying a sensor to collect sensor data corresponding to the real world action to be simulated;
storing the sensor-based message, the message defining parameter and the identified sensor; and
generating a billing event for the sensor-based message each time the real world action is sensed.

2. The method of claim 1, wherein the messaging item identification identifies an avatar, an emoticon, or an emoji.

3. The method of claim 1, wherein the definition of the sensor-based message further comprises an identifier of a reward for simulating the real world action.

4. The method of claim 1, wherein the sensor comprises at least one of a touch screen, a microphone, a camera, an accelerometer, a light sensor, a proximity sensor, temperature sensor, compass, and a gyroscope.

5. A method for sending a message during a text messaging session, comprising:
selecting, at a first computing device, a messaging item to include in a text messaging communication, the messaging item being associated with a real world activity to be simulated and an output to be displayed upon sensing a message trigger on the first computing device;
determining the message trigger required to transmit the messaging item;
collecting sensor data from a sensor in the first computing device;
comparing the collected sensor data to the determined message trigger to determine whether the real world activity is simulated; and
transmitting the text messaging communication to a second computing device,
wherein the message is displayed at the first computing device and the second computing device.

6. The method of claim 5, wherein the messaging item comprises an avatar, an emoticon, or an emoji.

7. The method of claim 5, wherein the sensor comprise at least one of a touch screen, a microphone, a camera, an accelerometer, a light sensor, a proximity sensor, temperature sensor, compass, and a gyroscope.

8. The method of claim 5, further comprising:
receiving, at the first computing device, a reward for performing the action.

9. The method of claim 8, wherein the reward comprises access to additional features of a computer application.

10. The method of claim 8, wherein the reward comprises a discount on a product or a service associated with the messaging item.

11. The method of claim 5, further comprising:
upon determining the real world activity is simulated, generating an output defined by the message; and
displaying the output.

12. A method for providing a message to a mobile computing device, comprising:
selecting a messaging item to associate with a message output, the message output being triggered by an action sensed using a sensor on the mobile computing device;
transmitting, to a server computing device, a description of an output to be displayed based on the action sensed; and
receiving a bill for the messaging item each time the action is sensed.

13. The method of claim 12, wherein the action replicates a real world activity.

14. The method of claim 12, further comprising:
transmitting, to the server computing device, a description of a reward to be provided each time the action is sensed.

15. The method of claim 12, wherein the item comprises an avatar, an emoticon, or an emoji.

16. The method of claim 12, wherein the reward comprises a discount on a product or a service associated with the messaging item.

17. The method of claim 12, wherein the reward comprises access to additional features of a computer application.

18. The method of claim 12, wherein selecting the messaging item comprises selecting a messaging item from an application store connected to the server computing device.
